(19) United States
(12) Patent Application Publication
(10) Pub. No.: US 2005/0036486 A1
(43) Pub. Date: Feb. 17, 2005

(54) Route discovery in ad-hoc networks with data packets

(76) Inventors: Zafer Sahinoglu, Somerville, MA (US); Philip Orlik, Cambridge, MA (US)

Correspondence Address: Patent Department;Mitsubishi Electric Research Laboratories, Inc., 201 Broadway, Cambridge, MA, 02139, US

(21) Appl. No.: 10/639,707

(22) Filed: Aug. 12, 2003

(51) Int. Cl. H04L 12/28

(52) U.S. Cl. 370/389; 370/351

(57) ABSTRACT

A route from a source node to a destination is discovered in an ad hoc network by having the source node generate a data packet including its source address, the destination address, and a field indicating that the source node requests route information from the source node to the destination node. The data packet is forwarded through the network until the data packet is received by the destination node. In response, the destination node generates a route reply packet including the route information. The route information can include a cost. The route reply packet is forwarded through the network until the route reply packet is received by the source node. During the forwarding, multiple route reply packets can be generated with different costs. The source node can then make cost calculations to select a best route based on the costs.

### FIELD OF THE INVENTION

The present invention relates to wireless networks, and more particularly to discovering routes in ad hoc networks.

### BACKGROUND OF THE INVENTION

An hoc network is a collection of communication nodes that does not have the centralized administration of a conventional network. In addition, the topology of an ad hoc network changes frequently. Nodes enter and exit the network at will, and the nodes of the network provide dynamic routing. Often, the nodes are mobile (wireless) and with limited resources.

Typical applications for ad hoc networks include military command and control, search and rescue, sensor, and disaster relief, offices, college campuses, homes, mobile wireless data networks, and many other mission critical resource operations, in these and other vital or security/safety-sensitive deployments.

Before nodes in an ad hoc network can communicate with each other it is first necessary to discover a route. An ad hoc, on demand, distance vector (AODV) protocol determines routes solely on-demand, see Perkins et al., “Ad hoc On-Demand Distance Vector Routing.” Proceedings of the 2nd IEEE Workshop on Mobile Computing Systems and Applications, pp. 90-100, February 1999.

This can be done as follows. When a source node has a packet to send to a destination node but does not have a route to that destination node, the source node broadcasts a route request (RREQ) packet. The packet specifies the destination and a unique RREQ broadcast identifier. Eventually, the destination node receives the request packet, and responds with a route reply packet. It is only after the source node receives the reply packet, that regular data packets can be forwarded.

During operation, the route cache needs to be maintained as nodes enter and exit the network. This requires a substantially complex routing algorithm, and a fairly large route cache.

It is desired to provide ad hoc routing for nodes without the complexity of the prior art routing algorithms.

### SUMMARY OF THE INVENTION

A route from a source node to a destination is discovered in an ad hoc network by having the source node generate a data packet including its source address, the destination address, and a field indicating that the source node requests route information from the source node to the destination node.

The data packet is forwarded through the network until the data packet is received by the destination node. In response, the destination node generates a route reply packet including the route information.

The route information can include a cost. The route reply packet is forwarded through the network until the route reply packet is received by the source node.

During the forwarding, multiple route reply packets can be generated with different costs. The source node can then make cost calculations to select a best route based on the costs.

### BRIEF DESCRIPTION OF THE DRAWINGS

FIG. 1 is a graph of an ad hoc network according to the invention;

FIG. 2 is a block diagram of prior art route discovery;

FIG. 3 is a block diagram of route discovery according to the invention;

FIG. 4 is a block diagram of a data packet according to the invention;

FIG. 5 is a block diagram of a route reply packet according to the invention;

FIG. 6 is a flow diagram of a process for processing a data packet according to the invention' and

FIG. 7 is a flow diagram of a process for processing a route reply packet according to the invention.

### DETAILED DESCRIPTION OF THE PREFERRED EMBODIMENT

Node Definitions

An ad hoc wireless communications network according to our invention includes a multitude of nodes. Each node includes a transceiver for transmitting and receiving data and control packets.

We define two type of nodes distinguished by their complexity and routing functionality: simple routing nodes (RN−), and complex routing nodes (RN+). The RN− nodes are extremely simple devices with limited resources, e.g., memory and processing power. The RN− nodes are not used to execute complex routing processes. The RN+ have significantly more memory and processing power and can therefore execute routing algorithms. The RN+ can also use a route cache to maintain routing information.

Our network 100 is heterogeneous and includes RN+ and RN− nodes that are homogeneously distributed. By that, we mean that any node has about an equal number of neighboring RN+ and RN− nodes. Our nodes only need to be able to generate and forward data and RREP packets. Our nodes are not required to understand or process prior art RREQ packets. Because we do not use RREQ packet, we enable a faster, cheaper, simpler and better ad hoc network

Let us describe the operation of the RN− nodes with respect to routing. Because RN− nodes do not store any routing information RN− nodes route packets using a simple process that does not require any storage. We do this by a method known as “tree-routing.”

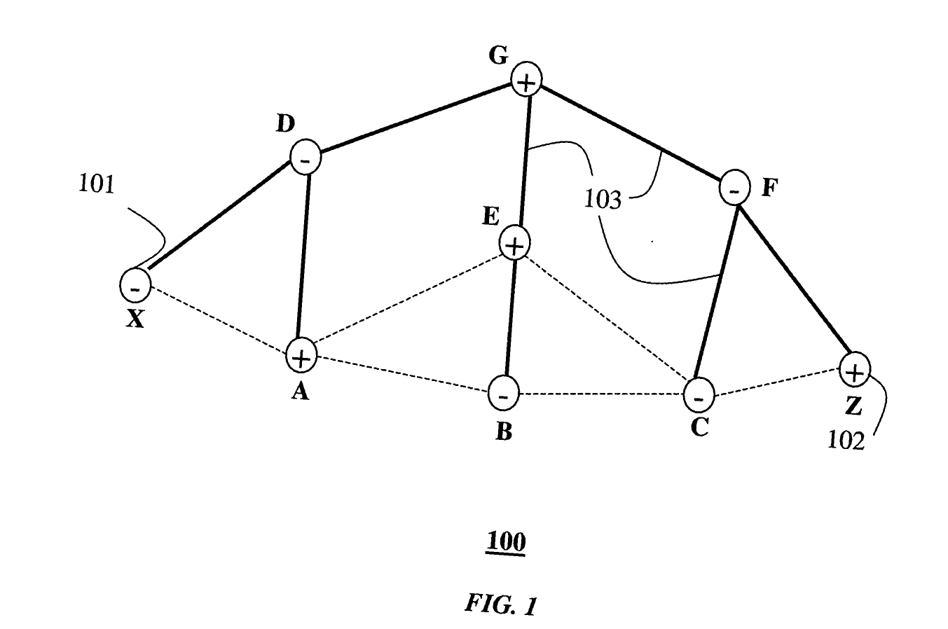

FIG. 1 shows a network 100 with nodes (A-G, X and Z) arranged as a tree, specifically a limited spanning. Node 101 is a source node, and node 102 is a destination node. To enable tree routing, all nodes in the network 100 have a limited understanding of the network topology. That is, the nodes are aware of the tree structure 100 that defines the network with parent/child relationships. Lines 103 connecting the nodes indicate the relationships. The lines 103 indicate potential communication links or hops. Multiple hops form a route.

Each node can determine whether another node is an ancestor, a descendant or neither ancestor nor descendant. In the example network 100, node E is the parent of node B, or equivalently, node B is the child of node E. Additionally, node D has descendant nodes X and A, and ancestor node G. All other nodes are neither descendants nor ancestors of node D. All nodes that have a common parent nodes are considered a ‘cluster’, e.g., nodes CZF, nodes XAD, and nodes BEG form clusters.

With this topology, our method routes packet among the nodes according to the tree structure. As an example of this routing, source node X 101 needs to send a data packet to destination node Z 102. Node X determines that node Z is neither a descendant nor an ancestor, and simply forwards the packet ‘up’ the tree to its parent node D. Node D also determines that node Z is neither a descendant nor an ancestor, and also forwards the packet up the tree to its parent node G.

Note, that node G is conventionally known as the ‘root’ of the tree 100. The root node knows all descendant nodes, and therefore can act as a coordinator node.

Node G determines that node Z 102 is its descendant. Therefore, node G forwards the packet down the tree to its child node F. Node F in turns forwards the packet to the destination Z 102. The overall route from node X to node Z is X→D→G→F→Z. This type of routing is called “tree-routing” and is based solely on the topology defined by the parent/child relationships.

Our RN− nodes only store parent/child relationships for themselves. From this information RN− nodes can determine whether other nodes are ancestors or descendants. In this way, a network including only RN− nodes is capable of routing packets to any other node in the network.

The problem with this approach is that routes are not determined based on cost, but only on the parent/child relationships. That is, there is now a way to improve the routes and nodes other than to direct parent or child nodes to forward packets.

A number of routing methods are known for routing packets through wireless networks. Most of those methods are based on simple cost metrics such as ‘hop’ count or ‘energy’ consumed during packet transmission.

An example of one such technique is the AODV routing algorithm. In AODV, the source node X 101 begins by discovering a route to destination node Z 102 by broadcasting a route request (RREQ) packet. The RREQ packet is forwarded through the network until it reaches the destination node Z. The destination node Z responds with a route reply (RREP) packet. The route from node X to node Z is determined by the intermediate nodes, which store the cost and next hop for the route to node Z, while the RREQ and RREP packet are forwarded.

For optimum route selection, the nodes must store information about costs when discovering routes. The costs are stored in a routing table that retains the next hop and cost for a given destination node. Using this type of routing technique nodes can determine the best possible route for a given cost metric.

FIG. 1 shows that there are a number of possible routes from node X to node Z. For example, the tree-route: XDGFZ and routes XABCZ and XAECB. By using the additional memory and processing power available in RN+ nodes, all three of these paths can be discovered and compared during route discovery.

However, this technique is not available to RN− nodes. For this reason, a number of RN+ nodes can be added to the network to help in discovering and using “better” routes. Of course in a heterogeneous network according including RN− and RN+ nodes according to the invention, it may not be possible to always discover the best route because of the RN− nodes do not store a routing table.

However, we provide a solution that discovers a majority of optimal routes, if they exist. In addition, we correctly combine the routes so that we do not force nodes to perform excessive packet forwarding or add too much route discovery traffic into the network, which reduces the available bandwidth.

Cost Calculation in RREQ and RREP Packets for Route Discovery

In RREQ based cost aware routing, the source node initiates a route request by broadcasting the RREQ packet. If an intermediate RN+ node receives the RREQ packet, then the RN+ node rebroadcasts the packet when it does not have a route entry for the destination. The rebroadcasting generates multiple RREQ packets. The RREQ packets, with different accrued costs, arrive at the destination node in some unknown order, after experiencing various time delays, depending on the routes the RREQ packets traveled.

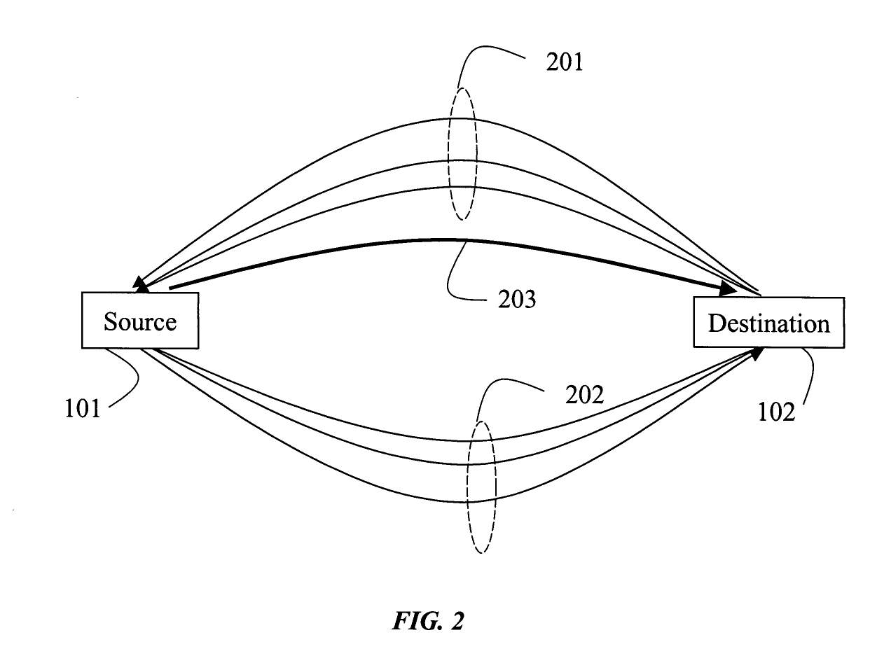

As shown in FIG. 2, the result is that the destination node generates and unicast another RREP packet to the source node whenever it receives a RREQ packet with a yet another lower cost than known before. The overall effect is that the route discovery generates multiple RREQs packets 201 from the source node to the destination node, and multiple RREP packets 202 from the destination node to the source node, and the source node must perform cost calculations on the multiple RREP packets to determine a RREP route 203 to use for transmitting data packets. Thus, cost calculation in RREQ packets mandates cost calculation in RREP packets for cost effective route discovery.

Cost Calculation in RREP Packets for Route Discovery

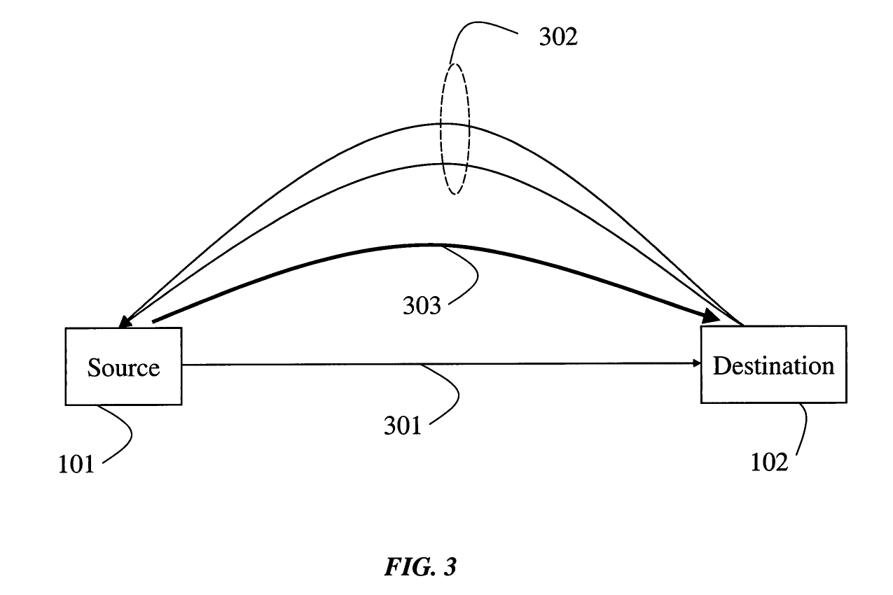

As shown in FIG. 3, the idea behind our invention is to perform cost calculation only after receiving the RREP packets 302. That is, only the source node is involved in performing the calculations to determine a best route.

We believe that this will result in less network traffic when compared to calculating costs in both RREQ and RREP packets, without degrading performance. We also take advantage of the existing tree structure to completely eliminate the need for RREQ packets during route discovery.

Instead of starting a search for a route with a RREQ packet, as in the prior art, our source node 301 immediately sends a data packet 301 to the destination 102 node using whatever knowledge the source node has of the network topology, e.g., as described above. Intermediate RN− nodes forward the data packet in the same manner. Intermediate RN+ node can use additional routing information to forward the data packets to the destination node, or they can use the tree structure.

Upon receiving the data packet, the destination node generates the RREP packet 302. The RN+ nodes forward the RREP packets towards the source node 301, therefore generating multiple RREP paths from destination node to the source node. Upon arrival of the RREP packets, the source node selects a best route 303 based on the cost of each route identified by RREP packets 302. Subsequent data packets follow the selected route.

Our route discovery method substantially reduces network traffic over known prior art methods.

Our route discovery method uses the tree-route for initial forwarding of data packets, and subsequently selects a better path if one exists. Our method does not require any RREQ packets, and therefore it is simpler than the prior art AODV method in that fewer packets are needed.

Packet Structures

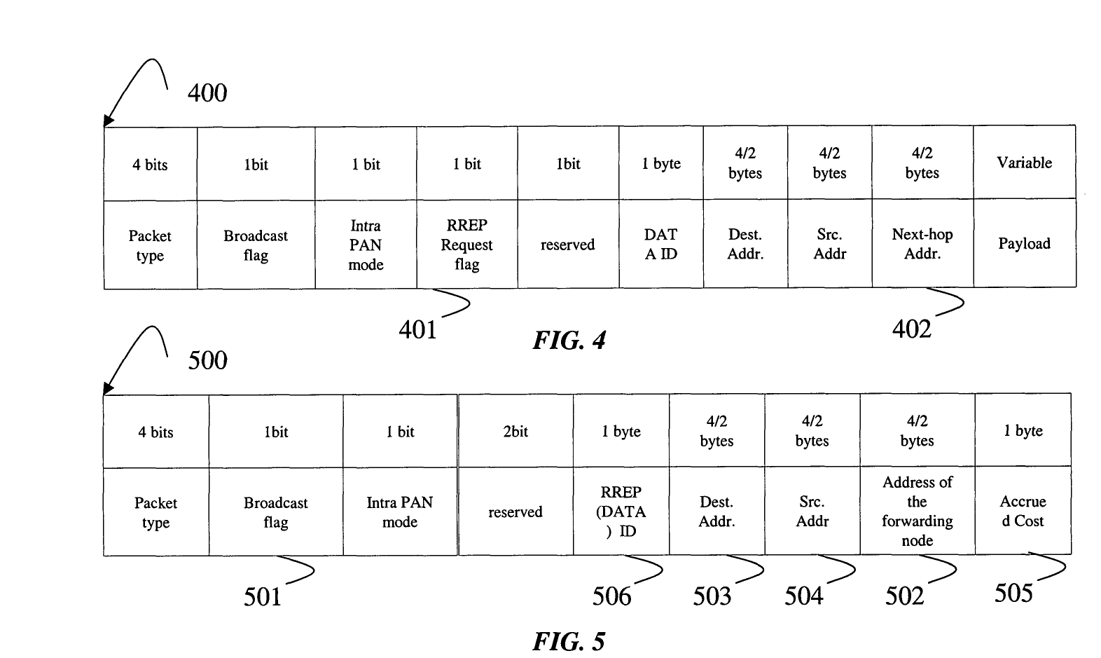

FIG. 4 shows a data packet 400 and FIG. 5 shows a RREP packet 500. The structure of most of the fields and bits in these two packets is conventional, except for the fields and bits explained in greater detail below. The top row indicates the number of bits or bytes, and the bottom row indicates the functionality of the bits and bytes.

Initially, the source node sends the data packet 400 to the destination node along the tree-route. The first data packet has a “RREP Request flag” field 401 set to 1. This field, in effect, makes the data packet act as a route request packet. A ‘NextHop Address” 402 is inserted by a forwarding node.

Upon receiving the data packet with the RREP request flag ‘on’, the destination generates the RREP packet 500. If the destination node is an RN− node, then the RREP packet is unicast along the tree-route back to the source node. The RN− destination node sets a “Broadcast flag” bit 501 to zero, and places its own address in a “next-hop addr” field 502. The destination node sets a “DestAddr” field 503 to the address of the source node, and a “SrcAddr” field 504 to the address of the source node of the data packet. The DestAddr and the SrcAddr fields do not change as the RREP packet is forwarded to the source node. An “AccCost” 505 is updated as the packet is forwarded.

Packet Processing

Depending on the node's type, RN+ or RN−, the processing of RREP packets is slightly different. We also assume that the both RN+ and RN− nodes can route packets using the routing-tree.

The following rules describe how nodes forward RREP packets. A RN− node always drops a RREP packet received from a node in another cluster, i.e., the receiving node is an immediate ancestor or descendant of the sending node.

A RN+ always broadcasts the RREP packet, as long as the RREP packet has a lower accrued cost according to the RREP ID 506 and the destination address 503.

By following these rules, the RREP packet can traverses several routes from the destination node back to the source node. As the RREP packet traverses the network, routing tables are established by RN+ nodes that forward the RREP packet. Each time the RN+ forwards a RREP packet from a particular destination node and with a particular RREP ID, it uses a lowest cost route. The source node can receive multiple RREP packets. If the source node is an RN+ node, the source node updates its routing table.

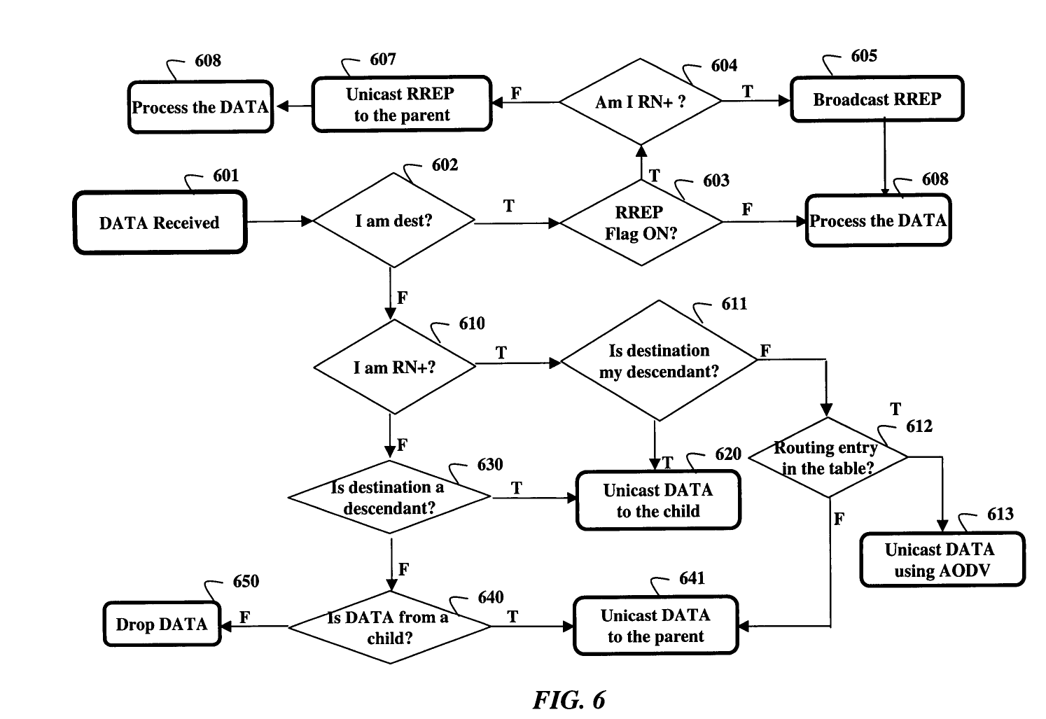

FIG. 6 shows the process followed upon receiving a data packet 601. The node determines 602 if it is the destination node. Determine 603 if the RREP flag 401 is on. If true, then determine 604 if the node is a RN+ node. If true, broadcast 605 the RREP packet, and process the data.

Otherwise, if not a RN+ node, then unicast 607 a RREP packet to the parent node, and process 608 the data packet.

If the node is not the destination node, then determine 610 if it is a RN+ node. If true, determine 611 if the destination node is a descendant node. If false, determine 612, if there is an entry in the routing table. If true, then unicast 613 the data packet.

If the destination node is a descendant node, then unicast 620 the data packet to the child node(s).

If the receiving node is neither the destination nor a RN+ node, then determine 630 if the destination node is a descendant node. If true, then unicast 620 the data packet to the child node(s).

Otherwise, if false, determine 640 if the data packet is from a child node. If true, then unicast 641 the data packet to the parent node. Otherwise, if false, then drop 650 the data packet.

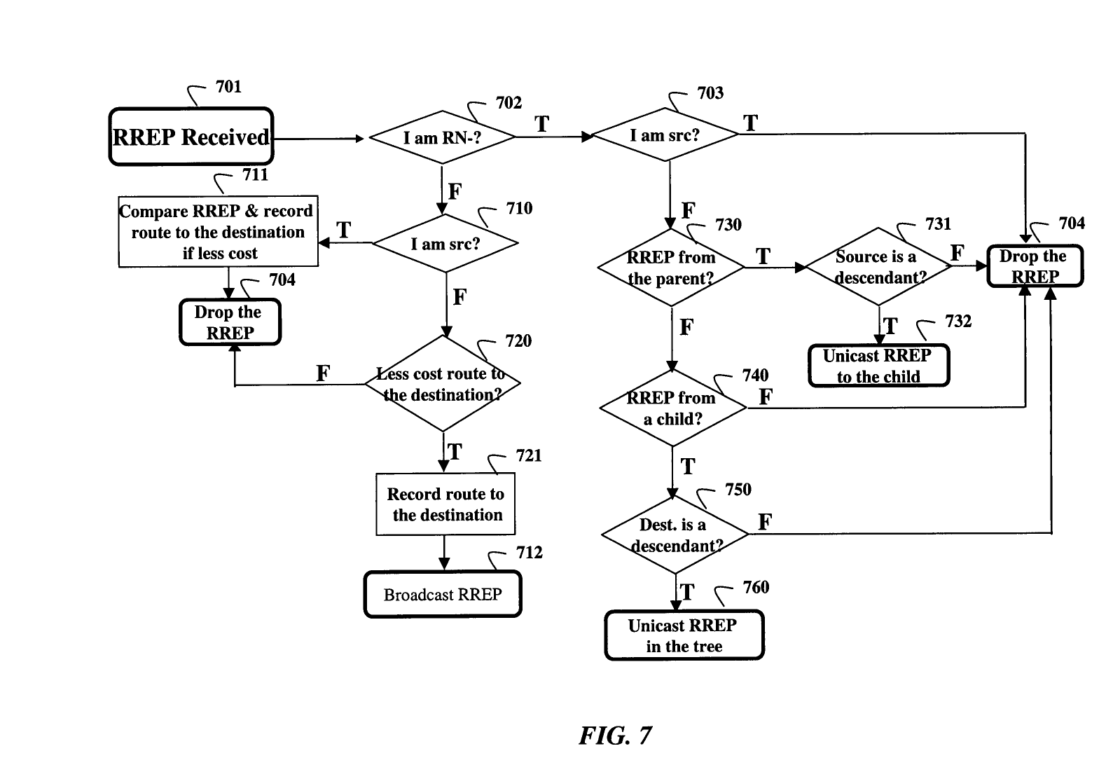

FIG. 7 shows the process followed upon receipt 701 of a RREP packet. The node determine 702 if it is a RN− node. If true, then determine 703 if it is the source node. If true, then drop 704 the packet.

Otherwise, if the node is not a RN− node, then determine 710 if it is the source node. If true, then record 711 the route if its the cost is less, otherwise drop 704 the RREP packet.

Otherwise, if the node is not the source node, then determine is the cost has decreased. If false, drop 704 the RREP packet. Otherwise, if true, then record the route to the destination, and broadcast the RREP packet.

It the node is neither a RN− node nor the source node, then determine 730 if the packet is from a parent node. If true, then determine 731 if the source node is a descendant node, and drop 704 the packet if false. Otherwise, unicast 732 the RREP packet to the child node.

If the RREO is not from the parent node, then determine 740 if the packet is from a child node, and drop 704 the packet if false. Otherwise, determine 750 if the destination node is a descendant node, and drop 704 the packet if false. Otherwise, unicast 760 the RREP packet in the tree.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. In a network including a plurality of nodes, a method for discovering a route from a source node to a destination, comprising:
generating, in the source node, a data packet including a source address, a destination address, and a field indicating that the source node requests route information for a route from the source node to the destination node;
forwarding the data packet through the network until the data packet is received by the destination node; and
generating, in the destination node, a route reply packet including the route information regarding the route; and
forwarding the route reply packet through the network until the route reply packet is received by the source node.

2. The method of claim 1, further comprising:
generating, in the source node, subsequent data packets, each subsequent data packet including the source address, the destination address, the field indicating that the source node has the route information, and the routing information;
forwarding the subsequent data packets through the network according to the routing information until the subsequent data packets are received by the destination node.

3. The method of claim 1, in which the plurality of nodes are arranged in a tree-like structure, and further comprising:
RN− nodes configured to forwarding the data and route reply packets according to the tree structure; and
RN+ nodes configured to forward the data and route reply packets according to route data stored in a route cache.

4. The method of claim 1, in which the network is ad hoc with the plurality of nodes entering and exiting network at will.

5. The method of claim 1, in which the route information includes a cost of the route.

6. The method of claim 1, in which only the source node determines a best route according to the cost.

7. The method of claim 1, in which multiple route reply packets are generated while forwarding the route reply packet, each of the multiple route reply packets including a particular cost, and further comprising:
determining, only in the source node, a best route according to the particular costs.

8. In a network including a plurality of nodes, a method for discovering a route from a source node to a destination, comprising:
generating, in the source node, a RREQ packet including a source address, a destination address, and a unique identification number and a cost field
forwarding the RREQ packet through the network until the RREQ packet is received by the destination node; and
generating, in the destination node, a route reply packet including the source address, the same unique identification number and the cost field; and
forwarding the route reply packet through the network until the route reply packet is received by the source node.
